(19) United States
(12) Patent Application Publication
(10) Pub. No.: US 2015/0093316 A1
(43) Pub. Date: Apr. 2, 2015

(54) PURIFICATION OF PF5

(71) Applicant: Honeywell International, Inc., Morristown, NJ (US)

(72) Inventors: Matthew H. Luly, Hamburg, NY (US); Bernard E. Pointner, Buffalo, NY (US)

(21) Appl. No.: 14/444,250

(22) Filed: Jul. 28, 2014

Related U.S. Application Data
(60) Provisional application No. 61/884,737, filed on Sep. 30, 2013.

(51) Int. Cl. C01B 25/10

(52) U.S. Cl. CPC C01B 25/10
USPC 423/301

(57) ABSTRACT

A method of purifying PF₅, which comprises the steps of (a) contacting a composition comprising PF₅ and an impurity with a super absorbent polymer or NaF, and (b) removing the composition from the super absorbent polymer or NaF, wherein the amount of the impurity in the composition is reduced. Compositions comprising PF₅, HF and super absorbent polymer or NaF.

### CROSS REFERENCE TO RELATED APPLICATIONS

The present application claims priority to U.S. Provisional Application Ser. No. 61/884,737, filed Sep. 30, 2013, the contents of which are incorporated herein by reference in its entirety.

### FIELD OF THE INVENTION

The present technology relates to the purification of phosphorus pentafluoride.

### BACKGROUND OF THE INVENTION

High purity PF₅ (phosphorus pentafluoride) is needed for many applications, including, for example, ion implantation, organic synthesis and LiPF₆ (lithium hexafluorophosphate) production.

LiPF₆ is an electrolyte often used in lithium ion batteries. Among commercially produced batteries, lithium ion batteries have one of the best energy-to-weight ratios, no memory effect, and a slow loss of charge when not in use. In addition to powering consumer electronics, lithium ion batteries are growing in popularity for defense, automotive, and aerospace applications due to their high energy density. See, e.g., U.S. Publication No. 2012/0003138, which is incorporated herein by reference in its entirety.

PF₅ is often contaminated with HF (hydrogen fluoride), however, which can interfere with the use of PF₅ in the desired application. HF contamination can result from the particular way PF₅ is produced or the reaction of PF₅ with trace water impurities in the raw materials or manufacturing process. For example, some known methods for preparing PF₅ include the treatment of polyphosphoric acid with excess HF to produce H₃OPF₆ (hexafluorophosphoric acid), which then reacts with excess HF and fuming H₂SO₄ (sulfuric acid) to produce PF₅. Another known method for preparing PF₅ comprises the fluorination of PCl₅ (phosphorus pentachloride) with HF to produce PF₅ along with HCl (hydrogen chloride).

Purifying PF₅ to remove contaminating HF is often difficult. Because of the ease with which PF₅ hydrolyzes, it is not possible, for example, to simply wash the PF₅ gas stream with water or caustic solutions to remove HF impurities.

There remains a need for more effective ways to purify PF₅. The present invention addresses this need.

### SUMMARY OF THE INVENTION

The present invention provides a method of purifying PF₅, which comprises the steps of (a) contacting a composition comprising PF₅ and an impurity with a super absorbent polymer, and (b) removing the composition from the super absorbent polymer, wherein the amount of the impurity in the composition is reduced.

In certain embodiments of the present invention, the impurity comprises HF. In other embodiments of the present invention, the impurity consists essentially of HF and the composition consists essentially of PF₅. In other embodiments of the present invention, the amount of the impurity in the composition is reduced by more than about 80% by weight. In other embodiments of the present invention, the amount of the impurity in the composition is reduced to about 5 vol % or less. In other embodiments of the present invention, the super absorbent polymer comprises or consists essentially of cross-linked polyacrylate-polyacrylamide copolymers. In other embodiments of the present invention, the super absorbent polymer has a molecular weight of from about 5,000 to about 5,000,000.

The present invention also provides a composition comprising PF₅, HF and super absorbent polymer. In certain embodiments of the present invention, the super absorbent polymer in the composition comprises cross-linked polyacrylate-polyacrylamide copolymers. In certain non-limiting aspects, the weight ratio of HF to the super absorbent polymer is about or less than about 60:1, in certain embodiments is about or less than about 10:1, and in further embodiments is about or less than about 1:1.

The present invention also provides a method of purifying PF₅, which comprises the steps of (a) contacting a composition comprising PF₅ and an impurity with NaF, and (b) removing the composition from the NaF, wherein the amount of the impurity in the composition is reduced.

The present invention also provides a composition comprising PF₅, HF and NaF. In certain non-limiting aspects, the weight ratio of HF to NaF is about or less than about 1:1, in certain embodiments is about or less than about 0.47:1, and in further embodiments is about or less than about 0.12:1.

### BRIEF DESCRIPTION OF THE DRAWINGS

FIG. 1 shows a scheme of the setup of a batch purification process using SAP. Crossed circles indicate valves.

FIG. 2 shows a scheme of the setup of a continuous flow purification process using SAP. Crossed circles indicate valves.

FIG. 3 shows a scheme of the setup of a parallel flow purification process. Crossed circles indicate closed valves and open circles indicated open valves. In this case, bed A is being regenerated (the valves connecting it to the PF₅ feed stream and the outflow are closed). N₂ flows through the heated bed A to remove HF. Meanwhile, bed B is being used for the removal of HF from PF₅. When bed B has reached capacity, the appropriate valves are opened and closed so that bed B is offline and regenerated and bed A is in operation.

FIG. 4 shows the IR spectrum of material recovered by static distillation after treatment of a PF₅/HF composition with SAP (superabsorbent polymer) (Example 1).

FIG. 5 shows the IR spectrum of material recovered during the regeneration of used SAP absorbent by dynamic (heated) distillation (Example 1).

FIG. 6 shows the IR spectrum of material recovered by static distillation after treatment of a PF₅/HF composition with NaF (Example 3).

FIG. 7 shows the IR spectrum of material recovered during the regeneration of used NaF absorbent by dynamic (heated) distillation (Example 3).

### DETAILED DESCRIPTION OF THE INVENTION

The inventors found that HF impurities can be removed from crude PF₅ by first contacting the HF/PF₅ mixture with a suitable material (for example a chemical compound or an absorbent) that has a higher binding affinity for HF than for PF₅, and then separating the purified PF₅ from the suitable material to which HF is bound.

Non-limiting examples of materials suitable for the separation of HF and PF₅ are NaF (sodium fluoride) and superabsorbent polymers (SAPs). The inventors found that organic SAP is, with respect to PF₅, un-reactive and resistant to oxidation, and that it has a higher binding affinity for HF than for PF₅. The invention was able to reduce the HF contamination in a PF₅/HF mixture from about 75 vol % HF to about 0.3 vol % HF.

The present invention provides a method of purifying PF₅, wherein the method includes contacting a composition comprising PF₅ and an impurity with a super absorbent polymer, and then removing the composition from the super absorbent polymer, thereby reducing the impurity in the composition.

The term super absorbent polymer (SAP) as used herein refers to any polymer or copolymer that has a higher binding affinity for HF than for PF₅. Such polymers or copolymers may be crosslinked. Non-limiting examples of such SAPs are cross-linked copolymers comprising polyacrylate and polyacrylamide monomer subunits. Such cross-linked polyacrylate-polyacrylamide copolymers are commercially available, for example, from Evonik Industries or one of its subsidiaries under the trade name Stockosorb®, in particular Stockosorb® M, Stockosorb® CW, Stockosorb® FW, and Stockosorb® SW.

The present invention provides a method of purifying PF₅, wherein the method includes contacting a composition comprising PF₅ and an impurity with NaF, and then removing the composition from the NaF, thereby reducing the impurity in the composition. Within the scope of the present invention, any material that provides a source of NaF may be used to practice the invention. A non-limiting example of such a material is NaHF₂, which may be heated under vacuum to provide NaF.

The contacting of a composition comprising PF₅ and an impurity with a SAP or other suitable material may be conducted in any of the ways usually practiced in the art. For example, the impurity-containing PF₅ may be purified in batch mode or by using a continuous flow system.

Batch purifications of PF₅/HF mixtures employ a bed of SAP or other suitable material (FIG. 1). The PF₅/HF mixtures can be mixed with this bed and then left in contact with it for a reasonable amount of time, followed by the removal of the PF₅, possibly under vacuum. The purified material is then recovered, for example in a cold-trap.

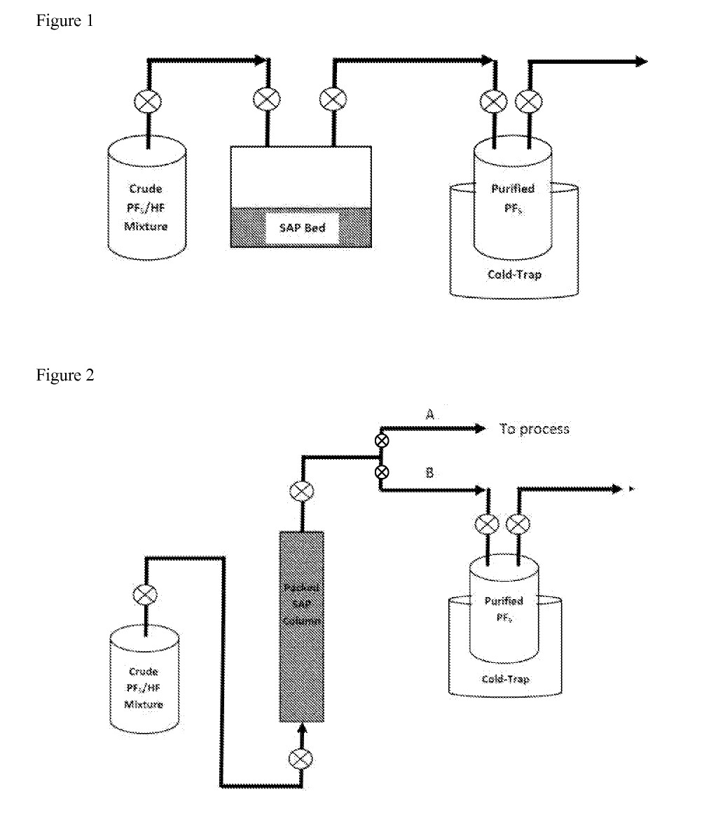

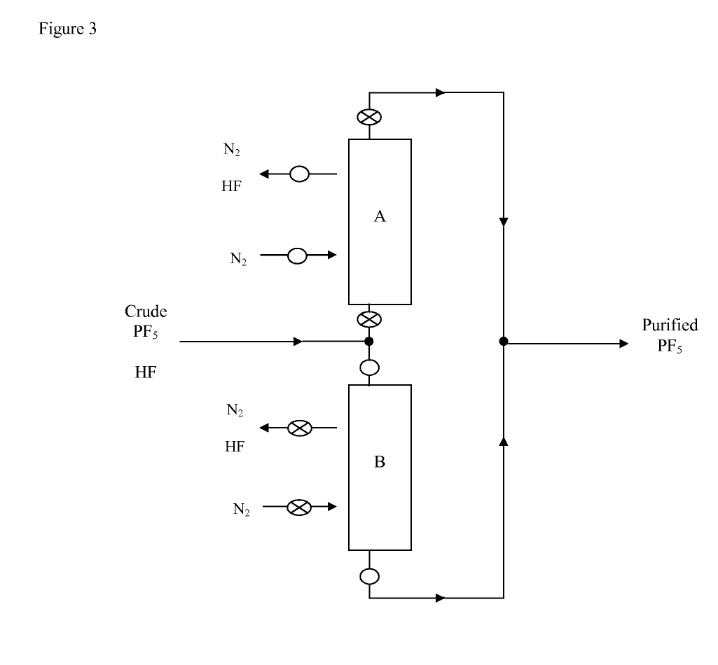

Purification with a continuous flow system involves passing a continuous stream of a PF₅/HF mixture through a packed column of SAP or other suitable material (FIG. 2). PF₅ is then recovered using a cold trap or compressor; or it is introduced directly into a process. In a continuous flow system, multiple packed beds may be used in series or in parallel. In parallel mode, one bed is continually used for purification operations while the other bed is regenerated offline. When the first bed nears saturation, it is taken offline for regeneration while the freshly regenerated bed is put on-line (FIG. 3).

The above provided description of purification systems that may be used is not meant to be limiting and the use of any other system commonly practiced in the art is also contemplated to be within the scope of the present invention.

The present invention is not limited to including PF₅, the impurity and the super absorbent polymer or NaF in a particular weight ratio. Rather, the present invention encompasses any composition comprising PF₅, the impurity and one or several super absorbent polymers and/or NaF. In certain non-limiting aspects, however, the weight ratio of the impurity to the super absorbent polymer is about or less than about 60:1, in certain embodiments is about or less than about 10:1, and in further embodiments is about or less than about 1:1. In further non-limiting aspects, the weight ratio of the impurity to NaF is about or less than about 1:1, in certain embodiments is about or less than about 0.47:1, and in further embodiments is about or less than about 0.12:1.

As part of the present invention, the PF₅-containing composition is removed from the super absorbent polymer, NaF or other suitable material. The scope of the present invention is not limited to a particular method of facilitating this removal. Rather, any kind of method may be used. These methods are generally known in the art and therefore not repeated here. Non-limiting examples of methods that facilitate the removal of PF₅ from the super absorbent polymer, NaF or other suitable material include the application of heat, vacuum or pressure (e.g., in the form of an inert sweep gas like N₂) to the composition comprising the PF₅, the impurity (for example HF) and the super absorbent polymer, NaF or other suitable material.

In certain embodiments of the present invention, the impurity comprises or consists of HF. It should be noted that the removal of other impurities from PF₅ is also contemplated to be within the scope of this invention. The present invention also encompasses the removal of HF impurities where additional non-HF impurities are present. These non-HF impurities may be removed together with the HF impurities, separately or not at all. Non-HF impurities not removed together with the HF impurities may include nitrogen gas.

In certain embodiments of the present invention, the amount of the impurity in the composition is reduced or substantially reduced. While not necessarily limited thereto, in certain aspects, the terms “reduced” or “substantially reduced” mean a reduction of the impurity level by more than about 80% by weight. In other embodiments, the amount of the impurity in the composition is reduced by more than about 85, 90, 95 or 99.7% by weight. The amount by which the impurity is reduced may be determined by any of the method commonly used in the art. A non-limiting example of such methods is IR (infrared) spectroscopy.

In certain embodiments of the present invention, the amount of the impurity in the composition is reduced or substantially reduced to about 0.3 vol % or less. In other embodiments, the amount of the impurity in the composition is reduced to about 5 vol % or less, about 4 vol % or less, about 3 vol % or less, about 2 vol % or less, about 1 vol % or less, or about 0.5 vol % or less. In even other embodiments, the amount of the impurity in the composition is reduced to from about 5 vol % to about 0.3 vol %. The amount of impurity present may be determined by any of the method(s) commonly used in the art. A non-limiting example of such methods is IR (infrared) spectroscopy. The term vol % as used herein refers to the relative amount in mole of a compound (e.g., of the impurity HF) present in a composition (e.g., a composition of PF₅). These ranges refer to HF impurities specifically, as well as to impurities comprising other non-HF impurities.

In certain embodiments of the present invention, the super absorbent polymer comprises or consists essentially of cross-linked polyacrylate-polyacrylamide copolymers. Such SAPs are commercially available, for example, from Evonik Industries or one of its subsidiaries under the trade name Stockosorb®. A number of different products are commercially available under this trade name, including, for example Stockosorb® M, Stockosorb® CW, Stockosorb® FW, and Stockosorb® SW. See, e.g., U.S. Pat. Nos. 7,914,761 and 8,153,096, which are incorporated herein by reference in their entirety. The use of all of these commercial products is considered part of this invention, as is the use of similar polymer products commercially available from the same or other companies. Similarly, the use of similar polymer products not commercially available is also considered to be within the scope of this invention.

The scope of this invention is not limited to copolymers with specific relative amounts and distributions of polyacrylate and polyacrylamide monomer subunits. Nor is the scope of this invention limited to copolymers with a specific degree and pattern of cross-linking. Furthermore, the present invention encompasses situations where two or more different cross-linked copolymers are used, or where cross-linked polyacrylate-polyacrylamide copolymers are used in conjunction with chemically different polymers or copolymers, which themselves may be cross-linked.

In certain embodiments of the present invention, the super absorbent polymer has a molecular weight of from about 5,000 to about 5,000,000 dalton. In other embodiments, the super absorbent polymer has a molecular weight of from about 5,000 to about 50,000, from about 50,000 to about 150,000, from about 150,000 to about 300,000, from about 3000,000 to about 1,000,000, or from about 1,000,000 to about 5,000,000 dalton.

The present invention also provides compositions comprising PF₅, HF and super absorbent polymer. The present invention is not limited to compositions including PF₅, HF and a super absorbent polymer in a particular weight ratio. Rather, the present invention encompasses any composition comprising PF₅, HF and one or several super absorbent polymers. In certain non-limiting aspects, however, the weight ratio of the HF to the super absorbent polymer is about or less than about 60:1, in certain embodiments is about or less than about 10:1, and in further embodiments is about or less than about 1:1.

Similarly, the present invention also provides compositions comprising PF₅, HF and NaF. The present invention is not limited to compositions including PF₅, HF and NaF in a particular weight ratio. Rather, the present invention encompasses any composition comprising PF₅, HF and NaF. In certain non-limiting aspects, however, the weight ratio of the HF to NaF is about or less than about 1:1, in certain embodiments is about or less than about 0.47:1, and in further embodiments is about or less than about 0.12:1.

The following examples further illustrate the invention, but should not be construed to limit the scope of the invention in any way.

### EXAMPLES

### Example 1

PF₅ and HF were separated by batch purification (FIG. 1). A bed of about 25 g SAP (Stockosorb® M product, available from Evonik Industries) was loaded into a 300 ml stainless steel cylinder fitted with stainless steel valves. The cylinder was connected to a stainless steel vacuum manifold and was heated to about 150° C. under vacuum for about 1 hour prior to use to dry the polymer. The final weight of the SAP after heating was 21.7 g, which means that the original SAP before drying had a water content of about 13.2% by weight. The cylinder containing SAP was then loaded with 5.2 g of anhydrous HF and 11.1 g of PF₅ and was left standing at room temperature overnight.

The contents of the SAP-filled cylinder were then statically distilled at room temperature into a second stainless steel cylinder (50 cc), which was liquid nitrogen cooled and under vacuum. 10.7 g of material were recovered in this fashion. The remaining material in the SAP-filled cylinder was recovered by dynamically pumping the contents of the SAP-filled cylinder at 150° C. through a third stainless steel cylinder cooled with liquid nitrogen. 2.8 g of material were recovered in this fashion.

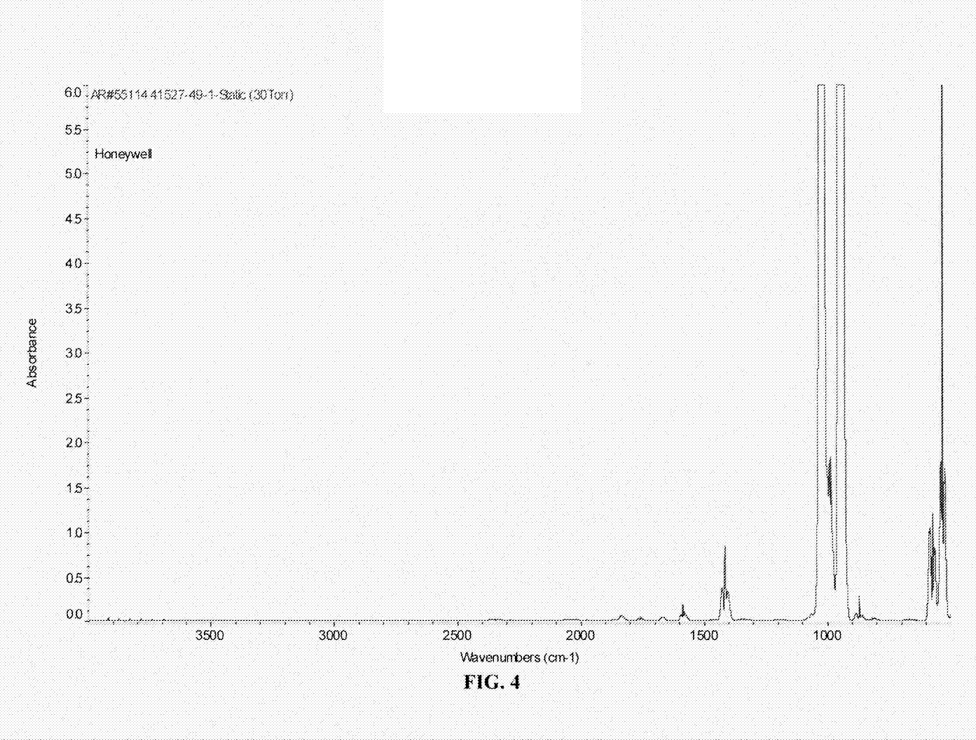

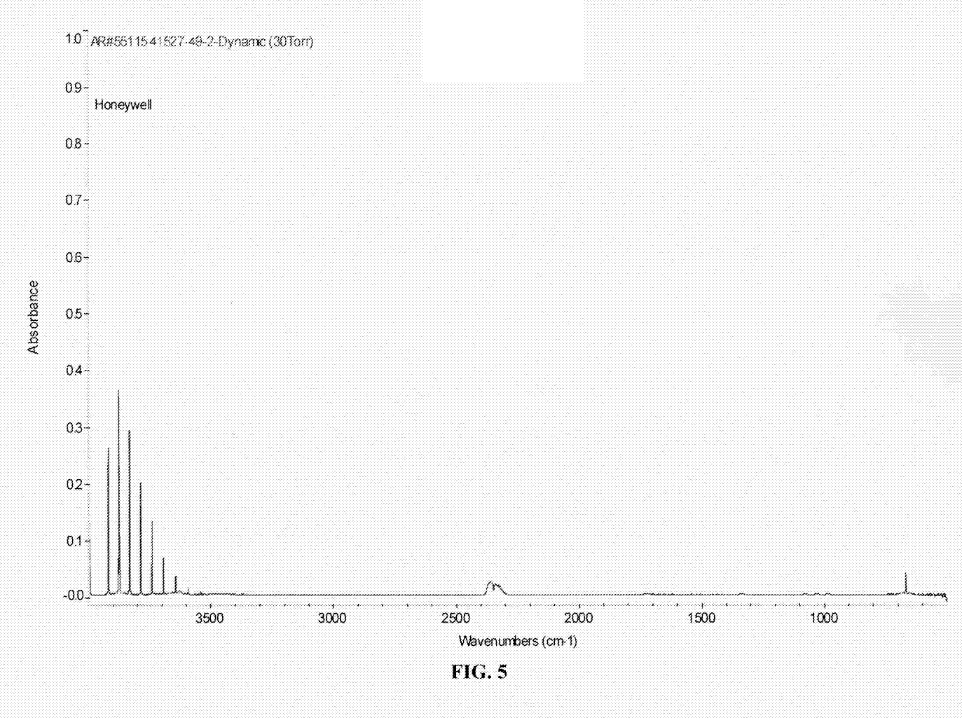

The material recovered by static distillation was analyzed by IR. The analysis of the IR spectrum revealed that the recovered material consisted overwhelmingly of PF₅ since the absorption spectrum showed only the PF₅-specific absorption bands in the region between about 2000 and about 500 cm⁻¹ (FIG. 4), and that it contained only about 0.3 vol % HF (as determined by a calibration curve) when compared to a starting value of about 75 vol % HF which was initially loaded onto the SAP-filled cylinder.

The material which was recovered by dynamic distillation was also analyzed by IR spectroscopy. This analysis revealed that the recovered material consisted mostly of HF since the spectrum showed primarily the HF-specific absorption bands between about 4000 and about 3500 cm⁻¹ (FIG. 5).

The spectra (FIGS. 4 and 5) indicated that HF was effectively separated from PF₅ using SAP. Since the SAP used in this experiment had not previously been exposed to HF, about 2.4 g of the HF originally loaded into the SAP-filled cylinder irreversibly reacted with the SAP's cations and could not be recovered. This irreversible reaction between SAP and HF commonly occurs upon the initial exposure of SAP to HF.

### Example 2

Example 1 was repeated using about 11 g of SAP, about 11 g of PF₅ and about 0.5 g of HF. After the removal of PF₅ and HF, the SAP was analyzed by ICP (inductively coupled plasma) spectroscopy and found to contain about 1,400 ppm of phosphorus. Since the SAP contained already about 500 ppm of phosphorus before the experiment was even conducted, the data indicated that PF₅ irreversibly reacts with the SAP only to a very limited degree.

### Example 3

PF₅ and HF were separated by batch purification. A bed of about 10 g of NaHF₂ was loaded into a 300 ml stainless steel cylinder fitted with a stainless steel valve. The cylinder was then slowly heated under dynamic vacuum to about 400° C. over a period of 5 hours. This yielded 6.70 g of NaF in the cylinder. The cylinder was then loaded with about 0.5 g of anhydrous HF and about 10.6 g of PF₅ and was left standing at room temperature overnight.

The contents of the NaP-filled cylinder were then statically distilled at room temperature into a second stainless steel cylinder (50 cc), which was liquid nitrogen cooled and under vacuum. About 5.5 g of material were recovered in this fashion. The remaining material in the SAP-filled cylinder was recovered by dynamically pumping the material at 400° C. through a third stainless steel cylinder cooled with liquid nitrogen. About 4.7 g of material were recovered in this fashion.

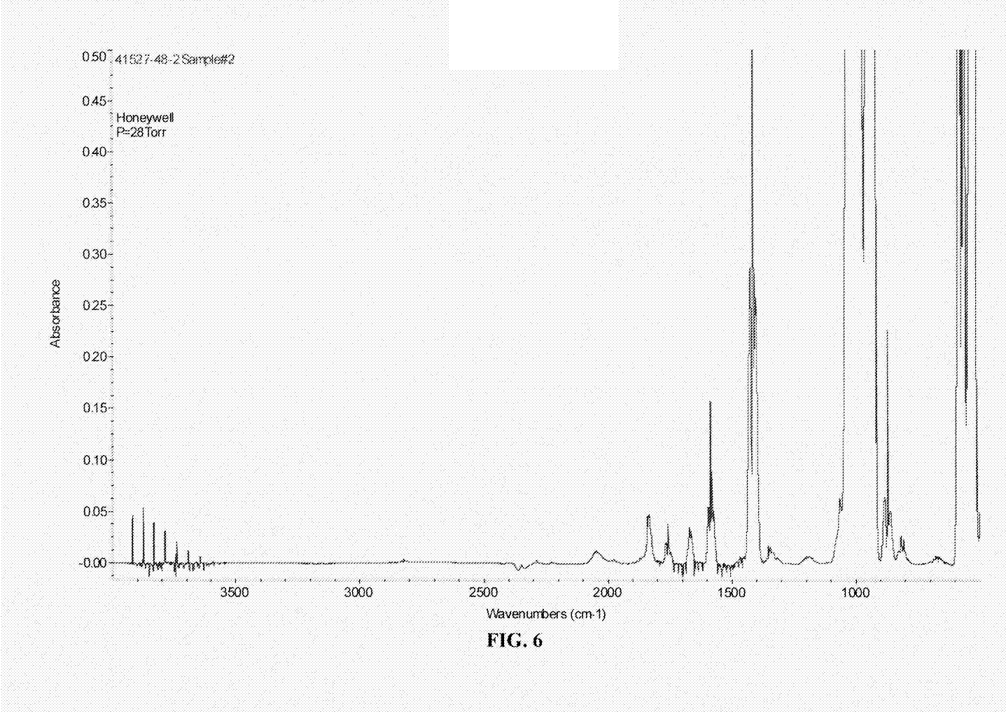

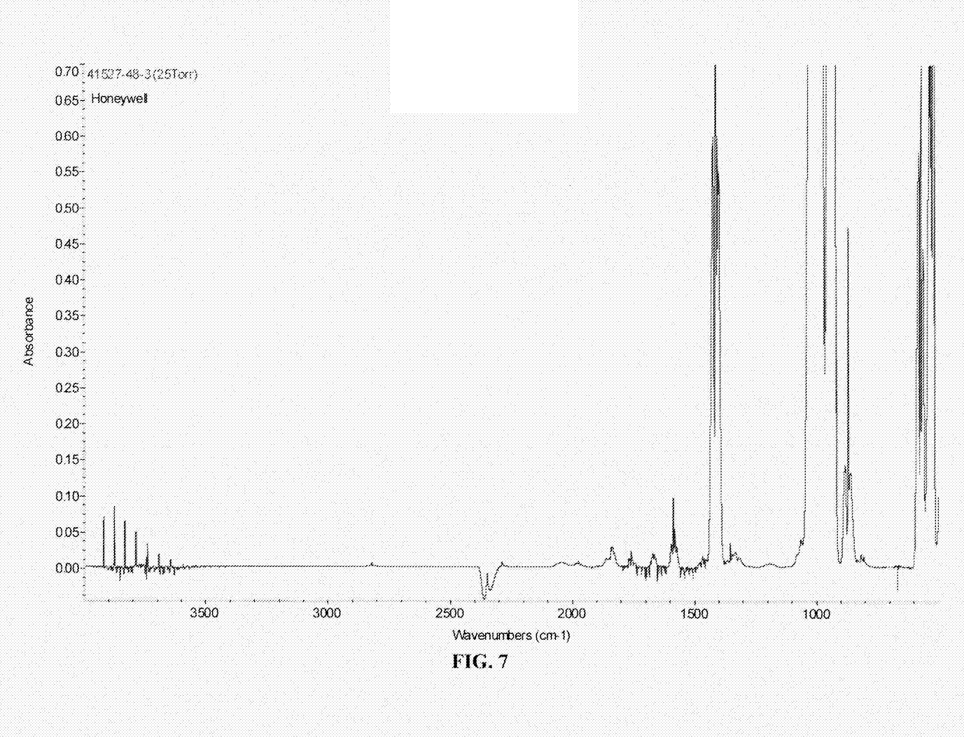

The material recovered by static distillation and the material recovered dynamically were analyzed by IR spectroscopy, as described in Example 1. The spectra (FIGS. 6 and 7) showed that not all PF₅ was recovered by static distillation and that the portion of the PF₅ that could be recovered only dynamically was slightly more contaminated with HF (FIG. 7; HF-specific signals are increased by comparison to FIG. 6). Therefore, NaF does remove HF from PF₅, but is not as effective as SAP in separating HF from PF₅.

### Example 4

Example 3 was repeated using about 10 g of NaHF₂, about 10.5 g of PF₅ and about 0.5 g of HF. After the removal of PF₅ and HF, the NaF pellets in the cylinder were analyzed by ICP (inductively coupled plasma) spectroscopy and found to contain about 17,000 ppm of phosphorus (1.7% by weight). Since the original NaHF₂ was found to contain <25 ppm phosphorus before the initial exposure to the PF₅/HF, the data indicated that PF₅ reacts with NaF extensively and is thus not completely recoverable.

### Example 5

PF₅ is purified using a continuous flow system. PF₅ containing about 1 vol % of HF is flowed through a column of SAP and the purified PF₅ analyzed by IR spectroscopy. The HF content is greatly reduced in the recovered PF₅.

### Example 6

Example 5 is repeated but the PF₅ contains about 10 vol % of HF. The HF content is greatly reduced in the recovered PF₅.

What is claimed is:

1. A method of purifying PF₅, the method comprising: (a) contacting a composition comprising PF₅ and an impurity with a super absorbent polymer, and (b) removing the composition from the super absorbent polymer, wherein the amount of the impurity in the composition in (b) is reduced, as compared to the composition in (a).

2. The method of claim 1, wherein the impurity comprises HF.

3. The method of claim 1, wherein the impurity consists essentially of HF and the composition consists essentially of PF₅.

4. The method of claim 1, wherein the amount of the impurity in the composition is reduced by more than about 80% by weight.

5. The method of claim 1, wherein the amount of the impurity in the composition is reduced to about 5 vol % or less.

6. The method of claim 1, wherein the super absorbent polymer comprises cross-linked polyacrylate-polyacrylamide copolymers.

7. The method of claim 1, wherein the super absorbent polymer consists essentially of cross-linked polyacrylate-polyacrylamide copolymers.

8. The method of claim 1, wherein the super absorbent polymer has a molecular weight of from about 5,000 to about 5,000,000.

9. A composition comprising PF₅, HF and super absorbent polymer.

10. The composition of claim 9, wherein the super absorbent polymer comprises cross-linked polyacrylate-polyacrylamide copolymers.

11. The composition of claim 10, wherein a weight ratio of HF to the super absorbent polymer is about or less than about 60:1.

12. The composition of claim 10, wherein a weight ratio of HF to the super absorbent polymer is about or less than about 10:1.

13. The composition of claim 10, wherein a weight ratio of HF to the super absorbent polymer is about or less than about 1:1.

14. A method of purifying PF₅, the method comprising: (a) contacting a composition comprising PF₅ and an impurity with NaF, and (b) removing the composition from the NaF, wherein the amount of the impurity in the composition is reduced.

15. The method of claim 14, wherein the impurity comprises HF.

16. The method of claim 14, wherein the impurity consists essentially of HF and the composition consists essentially of PF₅.

17. The method of claim 14, wherein the amount of the impurity in the composition is reduced by more than about 80% by weight.

18. The method of claim 14, wherein the amount of the impurity in the composition is reduced to about 5 vol % or less.

19. A composition comprising PF₅, HF and NaF.

20. The composition of claim 19, wherein a weight ratio of HF to NaF is about or less than about 1:1.
